(19) United States
(12) Patent Application Publication
(10) Pub. No.: US 2005/0197113 A1
(43) Pub. Date: Sep. 8, 2005

(54) Wireless telephone device associated with universal remote control function

(76) Inventors: Jao-Ching Lin, Hsin Chuang (TW); Tien-Shun Ma, Hsin Chuang (TW)

Correspondence Address: Ann Tsai;Suite 137, PmB 174, 931 West 75th Street, Naperville, IL, 60565, US

(21) Appl. No.: 10/792,703

(22) Filed: Mar. 5, 2004

(51) Int. Cl. H04Q 7/32; H04B 1/38

(52) U.S. Cl. 455/420; 455/566; 340/825.22

(57) ABSTRACT

A wireless telephone device associated with universal remote control function, being in conjunction with a phone main unit. The wireless telephone device includes a phone case, a control panel disposed on the cover with a plurality of functional buttons, a controller inside the case, a wireless phone module inside the case electronically connected to the controller for wireless phone signals being sent to and receiving from the main unit and performing transition between the voice signals, dial signals and wireless phone signals and a universal remote control module inside the case and electronically connected to the controller for remotely controlling a plurality of electrical home appliances. The control panel is commonly used with both the wireless telephone module and the universal control module. The functional buttons are operated such that the wireless telephone can be dialed and the electrical home appliances can be remote controlled as well.

### BACKGROUND OF THE INVENTION

1. Field of the Invention

The present invention is related to a telephone device, particularly a wireless phone device associated with universal remote control function.

2. Brief Description of Related Art

In current advanced hi-tech environment, most households are loaded with all kinds of electric home appliances, such as home entertainment audio, which are television, DVD, hi-fi stereo system and etc., and home appliance, which includes air conditioner, microwave oven, refrigerator and etc. These appliances have been considered as essential living equipment, and usually furnished with remote control function for user's convenience.

However, the more home appliances existed in the household, the more problems of being misplaced or being confused between different remote controllers. Such problems have created the need of universal remote controller to have one centralized device for remote control function of all kinds of electrical home appliances.

A wide variety of universal remote control devices are currently available in the market, such as “Take Control” made by Microsoft and “Universal Remote Commander” made by Sony and the personal digital assistant, “iP AQ”, made by Hewett-Packer. The preceding remote control devices are built in wireless control software “Nevo” to perform universal remote control function. These products are all designed as one centralized remote control unit to overcome the inconvenience of missing needed remote control unit or confusing between individual remote control units in the house.

On the other hand, most of households incorporate cordless phones in their telephone systems to enjoy the advantage of mobile phone capability without the restriction of telephone cord.

The concept of the invention is to combine benefits of a handy, portable wireless phone with the convenience of universal remote control unit to solve the missing or confusing problem due to multiple remote control units in the house.

### SUMMARY OF THE INVENTION

Accordingly, an object of the present invention is to provide a wireless telephone device associated with universal remote control function.

Another object of this invention is to furnish a wireless telephone with easy-to-operate display function.

In order to achieve above objects, the wireless telephone device of the present invention is in conjunction with a telephone main unit and includes a case, a control panel with a plurality of functional buttons on the case, a controller inside the case, a wireless phone module electronically connected to the controller and a universal control module also electronically connected to the controller. The wireless telephone module sends and receives the wireless phone via the phone main unit and performs transition between voice signals, dial signals and wireless phone signals. The universal remote control module is operated to control a plurality of electric home appliances remotely. Therefore, the control panel is shared with the wireless telephone module and the universal control module so that the functional buttons thereof are used for dialing the wireless telephone as well as to perform the remote control functions for electrical home appliances.

The wireless telephone device of the present invention further includes a display module located on the case and electronically connected to the controller for showing incoming phone number and operation prompts.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of the wireless telephone device associated with universal remote control function according to the present invention in a preferred embodiment thereof; and

FIG. 2 is block diagram illustrating a rechargeable battery being mounted for performing wireless phone functions in a normal mode and remotely controlling an electric home appliance while being switched to the universal remote control mode.

### DETAILED DESCRIPTION OF THE PREFFERED EMBODIMENT

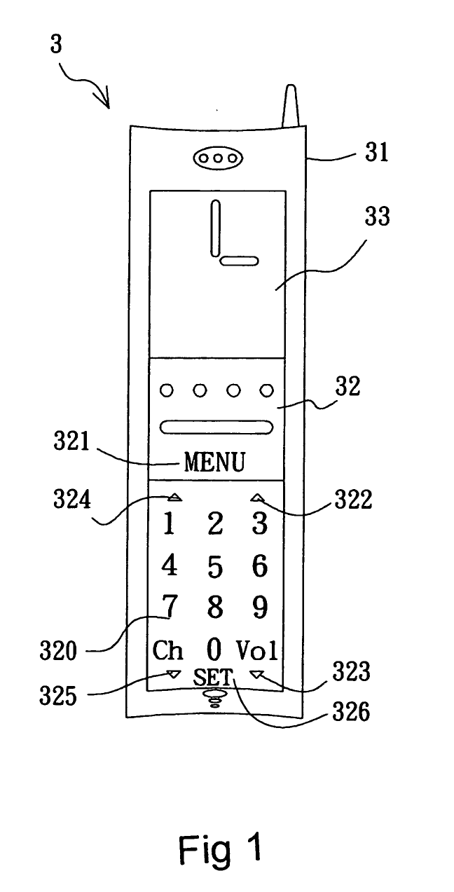

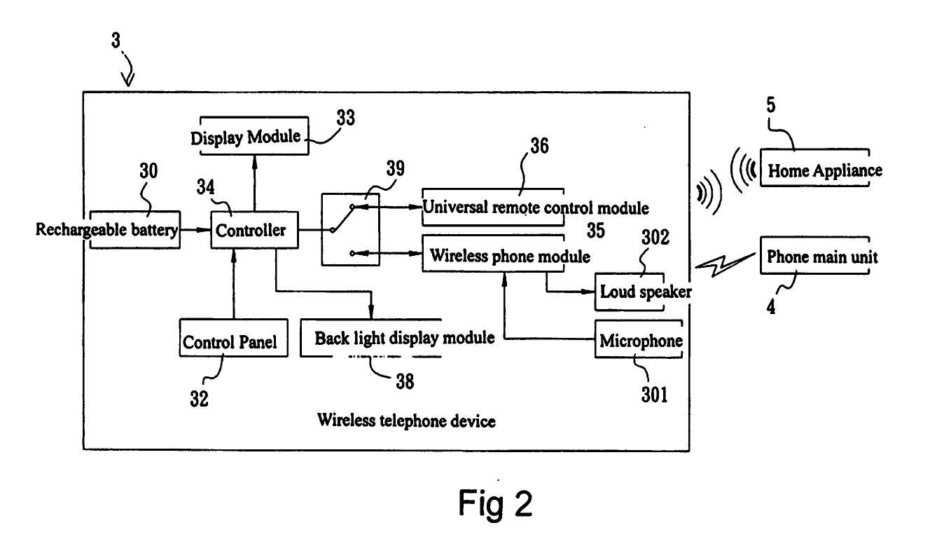

Referring to FIG. 1, a preferred embodiment of the wireless phone device 3 with universal remote control function is illustrated. The default mode of the wireless phone device 3 is wireless telephone function to communicate with a telephone main unit 4 (shown in FIG. 2). It communicates with the telephone main units by radio wave and will be further described later. The wireless telephone 3 includes a case 31, a control panel 32 on the case 31 and a display screen module 33 above the control panel 32. The display module 33 indicates various messages for wireless telephone, such as caller ID of incoming calls. The display module 33 also shows date and time with a small clock icon.

The control panel 32 is a touch type panel, with a plurality of functional buttons. These function buttons include a plurality of digital buttons 320, a menu button 321, two up-arrow buttons 322, 324, two down-arrow buttons 323, 325 and a select button 326. The digital buttons 320 are used for dialing phone numbers. Once the menu button 321 is pressed down, the display module 33 shows all the functions for remote controlling various home appliances. All the remote control functions are displayed on the screen as a tree-shaped diagram.

Besides, the two sets of up-arrow 322, 324 and down-arrow buttons 323, 325 in the present embodiment are remote control selections needed by the audio home appliances such as TV, DVD, or stereo system, etc. The up-arrow 322 and down-arrow 323 button set is for volume control, and the other up-arrow 324 and down-arrow 325 button set is for channel selection. Once the menu button 321 is pressed, the up-arrow 322 and down-arrow 323 buttons would be used to choose desired functions on displayed tree-shaped diagram. The select button 326 is used for confirming the chosen appliance.

In reference to FIGS. 1 and 2, the wireless phone unit 3 carries an internal controller 34, a wireless phone module 35 electronically connected to the controller 34, a universal remote control module 36, a switch 39 electronically connected to the controller 34 for being switched to the wireless telephone 35 or the universal remote control module 36. The wireless phone module 35 is also electronically connected to a microphone 301 and a loud speaker 302. Additionally, there is a built-in back light display module 38 behind the control panel 32 being a handy feature to show functional buttons in the dark.

In order to attain portability, the wireless phone unit 3 also has a rechargeable battery 30 electronically connected to the controller 34 to supply power needed by the wireless telephone 3. In normal operation mode, i.e., the universal remote control function being in an ineffective state, the wireless phone module 35 sends and receives wireless phone signals from the phone main unit, and performs transition between voice signals, dial signals and wireless phone signals. The phone module also works with the microphone 301 and the loud speaker 302 to receive and play voice signals.

In the meantime, the control panel 32 is used with the wireless phone module 35 to perform dialing function for the wireless phone. When the menu button 321 on control panel 32 is pressed and a home appliance is picked being controlled remotely, the switch 39 can be switched to the universal remote control module 36 from the original default wireless phone module 35 in order to implement universal remote control function. In this mode, the universal remote control module 36 operates to remotely control a plurality of electrical home appliances 5. At this moment, the control panel 32 is used with the universal remote control module 36 so that the functional buttons are operated to set for remote controlling the home appliances.

It is noted that the universal remote control module 36 in the present embodiment remotely controls the home electrical appliances 5 by way of infrared. However, other wireless remote control techniques would also be applicable to this preferred embodiment.

It is appreciated that the wireless telephone unit 3 associated with universal remote control function of the present invention has the advantages of being light and handy and being carried about easily. Further, the universal remote control function associated with remote control of various home electrical appliances so that it has solve the problem of inconvenience resulting from too many remote control devices such as the remote control devices being easy to get lost or being confused with each other while in use.

Moreover, the wireless phone device 3 with remote control function provides not only a friendly display module 33 but also a touch type control panel 32 with very easily operated input interface.

While the invention has been described with referencing to a preferred embodiment thereof, it is to be understood that modifications or variations may be easily made without departing from the spirit of this invention, which is defined by the appended claims.

1. A wireless telephone device associated with universal remote control function, being in conjunction with a phone main unit and comprising:
a phone case;
a control panel, being disposed on the cover with a plurality of functional buttons;
a controller, being inside the case;
a wireless phone module, being inside the case, being electronically connected to the controller for wireless phone signals being sent to and receiving from the main unit, and performing transition between the voice signals, dial signals and wireless phone signals; and
a universal remote control module, being inside the case and electronically connected to the controller for remotely controlling a plurality of electrical home appliances;
whereby, the control panel is commonly used by both the wireless telephone module and the universal control module and the functional buttons are operated such that the wireless telephone can be dialed and the electrical home appliances can be remote controlled.

2. The wireless telephone device associated with universal remote control function according to claim 1, wherein the control panel is a touch type panel.

3. The wireless telephone device associated with universal remote control function according to claim 1, wherein the wireless telephone device further comprises a display module is disposed on the case and electronically connected to the controller to display all the functions of wireless telephone and remotely control the electrical home appliances.

4. The wireless telephone device associated with universal remote control function according to claim 3, wherein the control panel is further provided with a menu button and all the functions for remotely controlling the electrical home appliances can be displayed once the menu button is pressed.

5. The wireless telephone device associated with universal remote control function according to claim 4, wherein all the functions are displayed with a tree shaped diagram.

6. The wireless telephone device associated with universal remote control function according to claim 5, wherein the control panel further has up-arrow and down-arrow buttons for being used to choose a specific electrical home appliance shown in the tree shaped diagram and a select button is provided to confirm the chosen electrical home appliance.

7. The wireless telephone device associated with universal remote control function according to claim 3, wherein the display module can show date and time.

8. The wireless telephone device associated with universal remote control function according to claim 7, wherein the display module to indicate time with a clock icon.

9. The wireless telephone device associated with universal remote control function according to claim 1, wherein a back light display module is disposed behind the control panel to show the functional buttons in the dark.

10. The wireless telephone device associated with universal remote control function according to claim 1, wherein the remote control module remotely controls the electric home appliances byway of infrared remote control technique.
